(19) United States
(12) Patent Application Publication
(10) Pub. No.: US 2022/0200723 A1
(43) Pub. Date: Jun. 23, 2022

(54) METHODS AND DEVICES IRREGULAR MODULATION TO AVOID RADIO FREQUENCY INTERFERENCE CAUSED BY CIRCUIT NON-LINEARITIES

(71) Applicant: Intel Corporation, Santa Clara, CA (US)

(72) Inventors: Oner ORHAN, San Jose, CA (US); Hosein NIKOPOUR, San Jose, CA (US); Mehnaz RAHMAN, San Jose, CA (US)

(21) Appl. No.: 17/131,867

(22) Filed: Dec. 23, 2020

(51) Int. Cl. H04L 1/00; H04L 7/033; H04L 7/00; H04L 27/34; H04W 24/08

(52) U.S. Cl. CPC H04L 1/0003; H04L 1/0009; H04W 24/08; H04L 7/0079; H04L 27/34; H04L 7/0331

(57) ABSTRACT

A communication device including one or more processors configured to generate a modulated signal, wherein the signal is modulated according to a modulation scheme; send the modulated signal; receive a signal error measurement signal representing a signal error of the modulated signal measured by a receiver of the modulated signal; determine a signal adjustment based on the signal error measurement signal; and adjust the modulation scheme based on the determined signal adjustment, wherein the modulations scheme defines a mapping of a plurality of constellation points to the modulated signal; and wherein the plurality of constellation points are configured according to a quadrature amplitude modulation, wherein the quadrature amplitude modulation comprises four corner constellation points.

### TECHNICAL FIELD

Various aspects of this disclosure relate generally to methods and devices for adjusting signal constellation schemes to reduce the impact non-linearities may have on performance.

### BACKGROUND

Communication Systems use Quadrature Amplitude Modulation (QAM) to transmit signals. For example, high carrier frequency and low power transceivers may modulate a signal according to a QAM constellation scheme. The communication system may incur circuit non-linearities. One type of non-linearity is saturation of circuit components due to a high amplitude received signal. Non-linearities may have an undesired impact on performance of the communication system. QAM schemes may be shaped to reduce the impact of non-linearities on the performance of the communication scheme.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various implementations of the disclosure are described with reference to the following drawings, in which:

FIG. 1 shows an exemplary radio communication network according to some aspects.

FIG. 2 shows an exemplary internal configuration of a terminal device according to some aspects.

FIG. 3 shows an exemplary communication system according to some aspects.

FIG. 4 shows exemplary constellations according to some aspects.

FIG. 5 shows exemplary constellation schemes according to some aspects.

FIG. 6 shows an exemplary method of performing constellation scheme adjustment at a communication device according to some aspects.

### DESCRIPTION

The following detailed description refers to the accompanying drawings that show, by way of illustration, specific details and aspects of implementations in which the disclosure may be practiced.

The word “exemplary” is used herein to mean “serving as an example, instance, or illustration.” The words “plurality” and “multiple” in the description and claims refer to a quantity greater than one. The terms “group,” “set”, “sequence,” and the like refer to a quantity equal to or greater than one. Any term expressed in plural form that does not expressly state “plurality” or “multiple” similarly refers to a quantity equal to or greater than one. The term “lesser subset” refers to a subset of a set that contains less than all elements of the set. Any vector and/or matrix notation utilized herein is exemplary in nature and is employed for purposes of explanation. Aspects of this disclosure described with vector and/or matrix notation are not limited to being implemented with vectors and/or matrices and the associated processes and computations may be performed in an equivalent manner with sets or sequences of data or other information.

As used herein, “memory” is understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

The term “terminal device” utilized herein refers to user-side devices (both portable and fixed) that can connect to a core network and/or external data networks via a radio access network. “Terminal device” can include any mobile or immobile wireless communication device, including User Equipments (UEs), Mobile Stations (MSs), Stations (STAs), cellular phones, tablets, laptops, personal computers, wearables, multimedia playback and other handheld or body-mounted electronic devices, consumer/home/office/commercial appliances, vehicles, and any other electronic device capable of user-side wireless communications.

The term “network access node” as utilized herein refers to a network-side device that provides a radio access network with which terminal devices can connect and exchange information with a core network and/or external data networks through the network access node. “Network access nodes” can include any type of base station or access point, including macro base stations, micro base stations, NodeBs, evolved NodeBs (eNBs), gNodeBs, Home base stations, Remote Radio Heads (RRHs), relay points, Wi-Fi/WLAN Access Points (APs), Bluetooth master devices, DSRC RSUs, terminal devices acting as network access nodes, and any other electronic device capable of network-side wireless communications, including both immobile and mobile devices (e.g., vehicular network access nodes, moving cells, and other movable network access nodes). As used herein, a “cell” in the context of telecommunications may be understood as a sector served by a network access node. Accordingly, a cell may be a set of geographically co-located antennas that correspond to a particular sectorization of a network access node. A network access node can thus serve one or more cells (or sectors), where the cells are characterized by distinct communication channels.

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (GSM), Code Division Multiple Access 2000 (CDMA2000), Universal Mobile Telecommunications System (UMTS), Long Term Evolution (LTE), General Packet Radio Service (GPRS), Evolution-Data Optimized (EV-DO), Enhanced Data Rates for GSM Evolution (EDGE), High Speed Packet Access (HSPA; including High Speed Downlink Packet Access (HSDPA), High Speed Uplink Packet Access (HSUPA), HSDPA Plus (HSDPA+), and HSUPA Plus (HSUPA+)), Worldwide Interoperability for Microwave Access (WiMax), 5G New Radio (NR), for example, and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers.

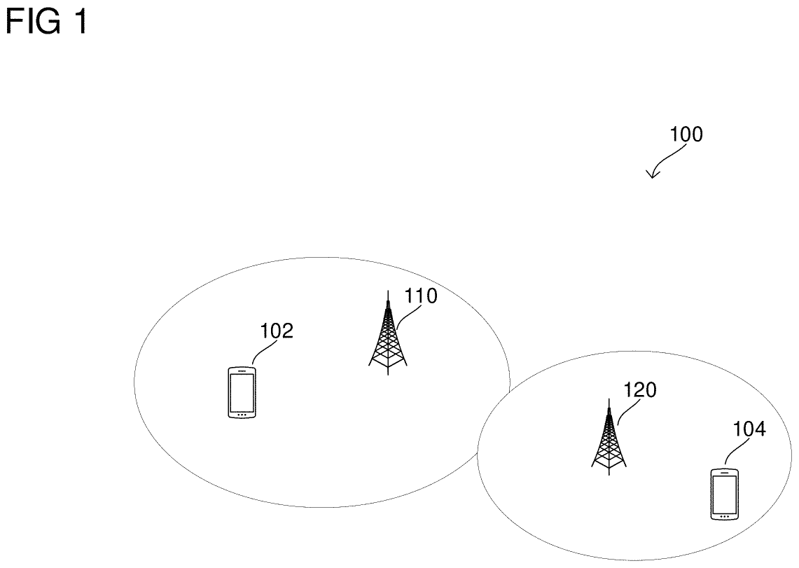

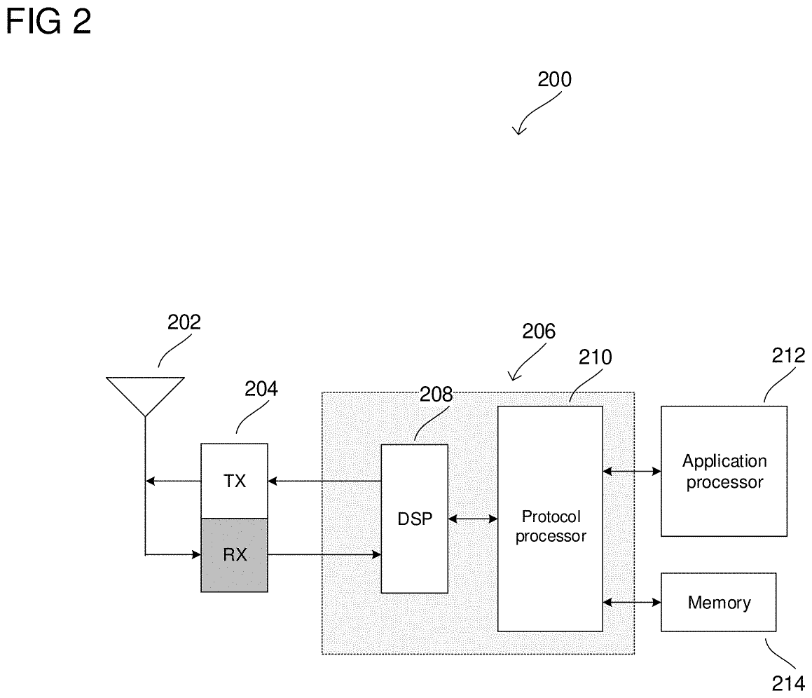

FIGS. 1 and 2 depict an exemplary network and device architecture for wireless communications. Starting with FIG. 1, FIG. 1 shows exemplary radio communication network 100 according to some aspects, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples may be applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks. The cellular core network may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks.

Network access nodes 110 and 120 may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104. The core network may also provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Terminal devices 102 and 104 and network access nodes 110 and 120 may therefore follow the defined communication protocols to transmit and receive data over the radio access network of radio communication network 100. The core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

FIG. 2 shows an internal configuration of terminal device 102 according to some aspects. As shown in FIG. 2, terminal device 102 may include antenna system 202, radio frequency (RF) transceiver 204, baseband modem 206 (including digital signal processor 208 and protocol controller 210), application processor 212, and memory 214. Although not explicitly shown in FIG. 2, in some aspects terminal device 102 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Terminal device 102 may transmit and receive radio signals on one or more radio access networks. Baseband modem 206 may direct this communication functionality of terminal device 102 according to the communication protocols associated with each radio access network. Baseband modem 206 may thus control antenna system 202 and RF transceiver 204 to transmit and receive radio signals according to the formatting and scheduling parameters for the communication protocols. In some aspects where terminal device 102 is configured to operate on multiple radio communication technologies, terminal device 102 may include separate communication components for each supported radio communication technology (e.g., a separate antenna, RF transceiver, digital signal processor, and controller).

Terminal device 102 may transmit and receive wireless signals with antenna system 202, which may be a single antenna or an antenna array that includes multiple antennas. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) for baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), with which RF transceiver 204 may convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals for antenna system 202 to wirelessly transmit. RF transceiver 204 may include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204. This may include specifying the radio frequencies RF transceiver 204 to transmit or receive on.

As shown in FIG. 2, baseband modem 206 may include digital signal processor 208, which may perform (digital) physical layer (PHY; Layer 1) transmission and reception processing. In the transmit path, digital signal processor 208 may prepare outgoing (digital) transmit data (from protocol controller 210) for transmission via RF transceiver 204. In the receive path, digital signal processor 208 may prepare incoming (digital) received data (from RF transceiver 204) for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or Field-Programmable Gate Arrays (FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., Application Specific Integrated Circuits (ASICs), FPGAs, and other hardware) that are digitally configured to specific execute processing functions. The one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Terminal device 102 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of terminal device 102 (antenna system 202, RF transceiver 204, and digital signal processor 208) according to the communication protocols of each supported radio communication technology. In some aspects, protocol controller 210 may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of terminal device 102 to transmit and receive communication signals according to the protocol stack control logic in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to transfer application layer data to and from radio terminal device 102 with the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Terminal device 102 may also include application processor 212 and memory 214. Application processor 212 may be a CPU configured to handle the layers above the protocol stack, including the transport and application layers. Application processor 212 may be configured to execute various applications and/or programs of terminal device 102 at an application layer of terminal device 102. These applications and/or programs may include an operating system (OS), a user interface (UI) for supporting user interaction with terminal device 102, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of terminal device 102, such as a hard drive or another such permanent memory device. Although not explicitly depicted in FIG. 2, the various other components of terminal device 102 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between network access nodes of the radio access network of radio communication network 100. As each network access node of radio communication network 100 may have a respective coverage area, terminal devices 102 and 104 may be configured to select and re-select between the available network access nodes to maintain a strong radio link with the radio access network of radio communication network 100. For example, terminal device 102 may establish a radio link with network access node 110 while terminal device 104 may establish a radio link with network access node 120. In the event that the current radio link degrades, terminal devices 102 or 104 may seek a new radio link with another network access node of radio communication network 100. For example, terminal device 104 may move from the coverage area of network access node 120 into the coverage area of network access node 110. As a result, the radio link with network access node 120 may degrade. Terminal device 104 may detect that degradation with radio measurements such as signal strength or signal quality measurements of network access node 120. Depending on the mobility procedures defined in the appropriate network protocols for radio communication network 100, terminal device 104 may seek a new radio link (which may be, for example, triggered at terminal device 104 or by the radio access network). In some cases, terminal device 104 may search for a new radio link by performing radio measurements on neighboring network access nodes to determine whether any neighboring network access nodes can provide a suitable radio link. As terminal device 104 may have moved into the coverage area of network access node 110, terminal device 104 may identify network access node 110 (which may be selected by terminal device 104 or selected by the radio access network) and transfer to a new radio link with network access node 110. These mobility procedures, including radio measurements, cell selection/reselection, and handover, are defined in the various network protocols.

This disclosure provides various aspects for devices to adjust constellation points in a constellation scheme. QAM may introduce non-linearities. Shaping of corner constellation points of QAM scheme at the transmitter may eliminate or reduce non-linearities. Shaping to reduce non-linearities may include expanding corner constellations of a QAM scheme in a diagonal direction. The result is an irregular QAM constellation to mitigate nonlinearities.

Methods of mitigating non-linearites include digital pre-distortion to inverse the impact of power amplifier (PA) non linearities and adaptive training at a receiver. Inversing the impact of PA non-linearity is complex and requires a training circuit. Configuring a receiver to select or filter frequency channels offer little benefit in reducing non-linearities. These methods require a training circuit and are power hungry and bulky. It is desirable to find alternatives for avoiding or reducing non-linearity impact without requiring so many resources.

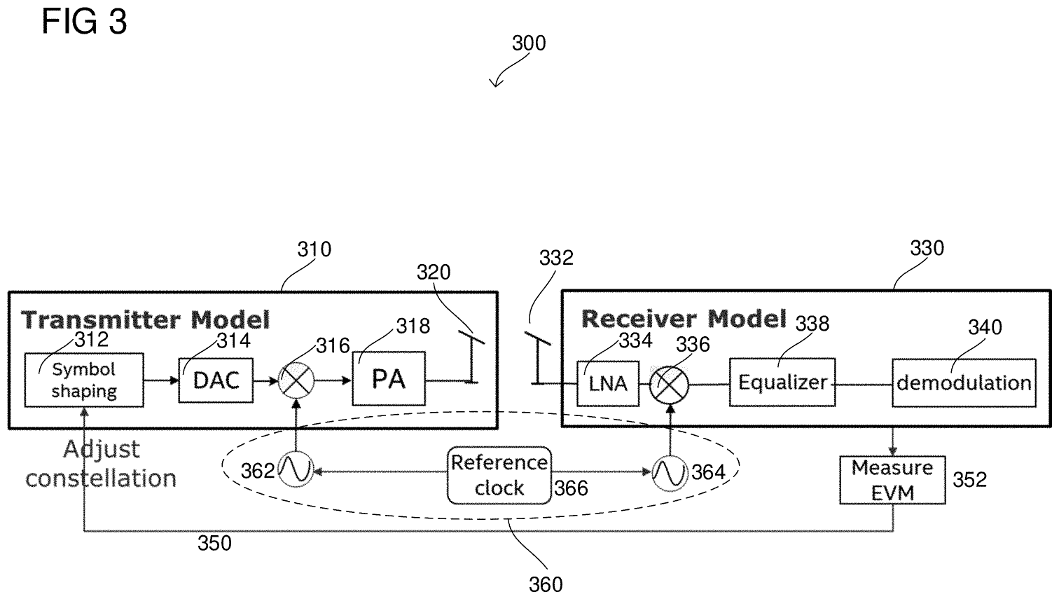

FIG. 3 depicts a communication device including transmitter 310 and receiver 330. Transmitter 310 (which may be similar to transmit path of radio frequency (RF) transceiver 204) may include symbol/pulse shaping module 312, digital to analog convertor 314, frequency mixer 316, PA 318, and antenna 320. Transmitter 310 may generate a signal according to a constellation scheme executed by symbol shaping module 312 and transmit the signal from antenna 321. Receiver 330 (which may be similar to receiver path of radio frequency (RF) transceiver 204) may include antenna 332, low noise amplifier 334, frequency mixer 336, equalizer 338, and demodulation module 340. Receiver may receive the signal via antenna 332 and determine a signal error measurement based on the received signal. Transmitter 310 and receiver 330 may communicate through communication channel 350. For example, communication channel 350 may be a wireline back-channel which includes a back-channel for transmitter configurations. Transmitter configurations may include adjusting a pre-emphasis equalizer. A signal including the signal error measurement 352 may be sent from receiver 330 to transmitter 310 via communication channel 350. Transmitter 310 and Receiver 330 may also communicate through feedback loop 360. Feedback loop 360 may include local oscillators 362 and 364. Reference clock 366 may be communicated through feedback loop 360 to determine an error measurement. Communication channel 350 and feedback loop 360 may be configured to use the same back-channel to communicate error messages.

Transmitter 310 may transmit a signal. Receiver 330 may receive the signal and compare the signal with reference clock 362 to determine any non-linearities and generate signal error measurement 352. Local oscillators 362 and 364 in combination with frequency mixers 316 and 336 respectively may adjust the signal frequency to allow transmitter 310 and receiver 330 respectively to process signals.

The transmitter 310 may adjust the four corner constellation points of a constellation scheme to reduce signal distortion. A constellation scheme may be configured to equally space constellation points. However, adjacent constellation points may interfere with each other and contribute to signal errors. Transmitter 310 may be configured to dynamically adjust the four corner constellation points of a constellation scheme to reduce or even avoid interference which may contribute to signal errors. Alternatively, the transmitter 310 may be configured with a fixed constellation scheme which includes already adjusted corner constellation points. The four corner points are more likely to contribute to a signal error and reducing the interference between the four corner points and its adjacent constellation points, will have a greater impact on reducing the signal error as compared to adjusting other constellation points

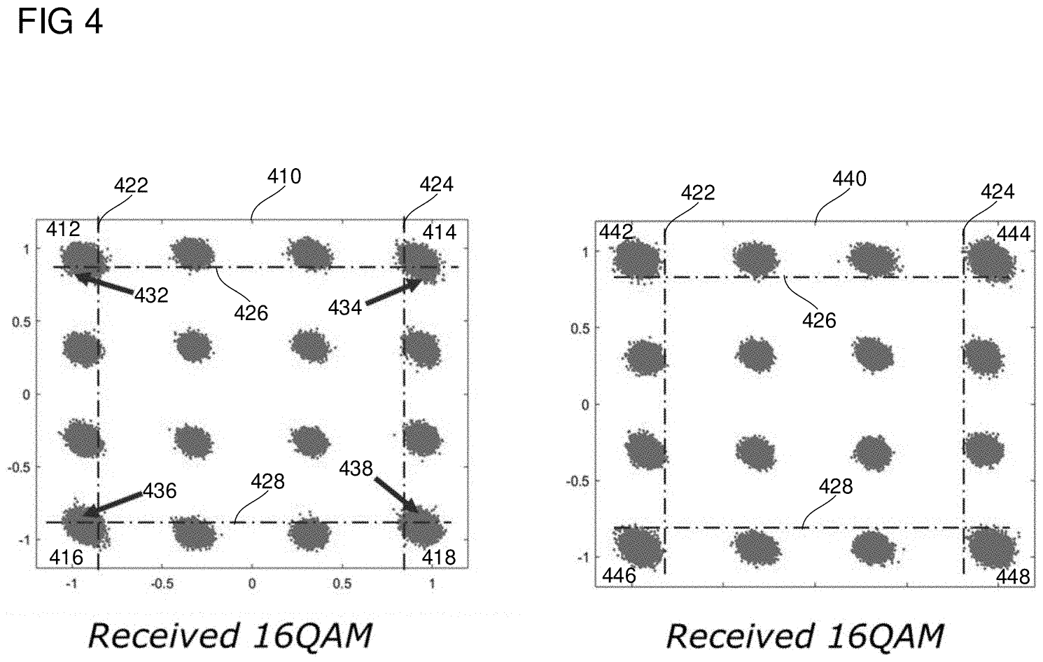

The power efficiency is important in wireless chip to chip communication. A communication device's operating circuit components near a saturation point may be useful for reducing power dissipation and relaxing design constraints. Wireless chip to chip communications require very low bit error ratio (BER). For example, a BER 10⁻¹² is acceptable. However, due to power efficiency requirements, there is significant phase noise, IQ imbalance, PA non-linearities, and receiver non-linearities. All these impairments together impact mostly corner constellations based on constellation points of a constellation scheme. The corner constellations points become a main contributor of high BER as shown in FIG. 4. Noisy corner constellations are closer to adjacent constellations and contribute more to BER. Therefore, addressing the noise generated by corner constellations will have the greatest impact on reducing non-linearities.

Expanding a distance between corner constellations and adjacent constellations will have the greatest impact against impairment to reduce overall BER. In this disclosure, methods and devices for expanding a distance between corner constellation points and adjacent constellation points may make the communication device more resistant to radio frequency interference (RFI) without drastically increasing power consumption. However, operating the PA at its maximum voltage may yield the most benefit.

FIG. 4 depicts two constellation results 410 and 440. First constellation result 410 may not consider the signal error and the four corner constellations 412, 414, 416, and 418 may interfere with other constellations in first constellation result 410. As constellations bleed across lines 422, 424, 426, and 428 they interfere with adjacent constellation points. Radio frequency interference or noise may be depicted as interference 432, 434, 436, and 438.

Second constellation result 440 depicts a result of a constellation scheme after considering a signal error measurement. Second constellation result 440 adjusts four corner constellation points 442, 444, 446, and 448 to a second position as compared to the first position of four corner constellation points 412, 414, 416, and 418 of the first constellation result 410. The adjusted positions of four corner constellation points 442, 444, 446, and 448 of the second constellation result 440 may avoid or reduce interference 432, 434, 436, and 438. As shown in the second constellation result 440, the four corner constellation points 442, 444, 446, and 448 have little or no bleed across lines 422, 424, 426, and 428. Therefore, resulting in a reduced signal error or noise.

In cases of dynamic or fixed constellation scheme reshaping, the adjusted constellation points minimize the error vector magnitude (EVM) or bit error rate (BER) of a received signal. As shown in FIG. 4 second constellation result 440, the irregular constellation scheme keeps corner constellation points away from adjacent constellation points, but does not adjust other constellation points. This constellation reshaping happens at baseband frequency. The baseband frequency may be defined as 0 to bandwidth of the transmitted signal, where the he bandwidth can be any valid value.

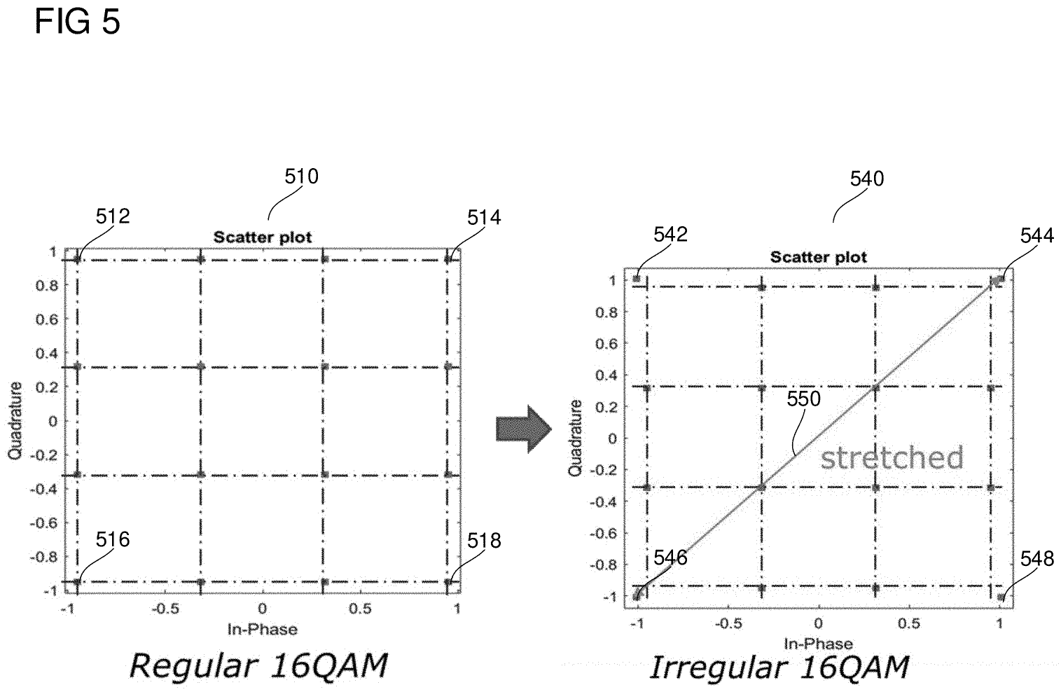

FIG. 5 depicts scatter plots of constellation points of constellation schemes 510 and 540. First constellation scheme 510 may be a configuration of first constellation result 410. Without information regarding a signal error, the constellation scheme equally spaces constellation points across a square grid as shown in 510. After receiving signal error measurement such as interference 432, 434, 436, and 438, transmitter 310 may adjust its constellation scheme scatter plot. Transmitter 310 may adjust the four corner constellation points of its constellation scheme diagonally. For example, corner constellation points 512 and 518 may be stretched diagonally with respect to each other. Similarly, corner constellation points 514 and 516 may be stretched diagonally with respect to each other as shown in second constellation scheme 540.

Second constellation scheme 540 depicts an adjusted constellation scheme based on a received signal error measurement. To reduce noise, transmitter 310 may adjust the four corner constellation points as previously described. For example, corner constellation points 546 and 544 have been stretched diagonally along line 550. Similarly, corner constellation points 542 and 548 have been stretched along a diagonal line (not shown) between them. The result is that corner constellation points 542, 544, 546, and 548 have a larger distance with respect to adjacent constellation points as compared to corner constellation points 512, 514, 516, and 518. The constellations based on the constellation points of constellation scheme 540 may have reduced or no interference with adjacent constellations as compared to constellations based on the first constellation scheme 510.

FIG. 5 depicts a 16 QAM constellation scheme. However, this method of adjusting the constellation points may be used with other modulation schemes. For example, 64 or 256 QAM.

Transmitter 310 may pre-shape the corner constellation points of a QAM scheme to avoid interference. To pre-shape the corner constellation points, opposite corner constellation points may be expanded diagonally from each other. The result will be an adjusted or irregular QAM constellation scheme to mitigate non-linearities.

Constellation pre-shaping may be accomplished by the digital to analog convertor (DAC). For example, in 16 QAM the DAC may take in a 4 bit digital input to determine the position of each constellation point of the constellation scheme. Each constellation point will be made up of 4 bits and coordinates identifying its position within a grid. The position of the four corner constellation points within the grid will be adjusted to consider the signal error measurement. This method may not require any reconfiguration at the receiver.

Prior to implementing the adjusted constellation scheme, the transmitter may determine a benefit measurement and compare it to a benefit threshold. For example, if there is a predetermined threshold for reducing signal noise, the transmitter may compare the benefit measurement with the benefit threshold.

If adjusting the constellation scheme does not yield a significant benefit, it may not be worth adjusting the constellation scheme. For example, if the benefit measurement of adjusting the constellation scheme only yields a 5% reduction in noise, but the benefit threshold hold for adjusting the constellation scheme is 10%, the transmitter 310 may determine it is not worth the effort of adjusting the constellation scheme.

The benefit threshold may be determined after considering several factors. For example, the added power consumption of constellation reshaping. A method may determine a ratio of added power consumption to noise reduction. If the power consumption is too large relative to noise reduction, the method may determine not to implement the constellation reshaping.

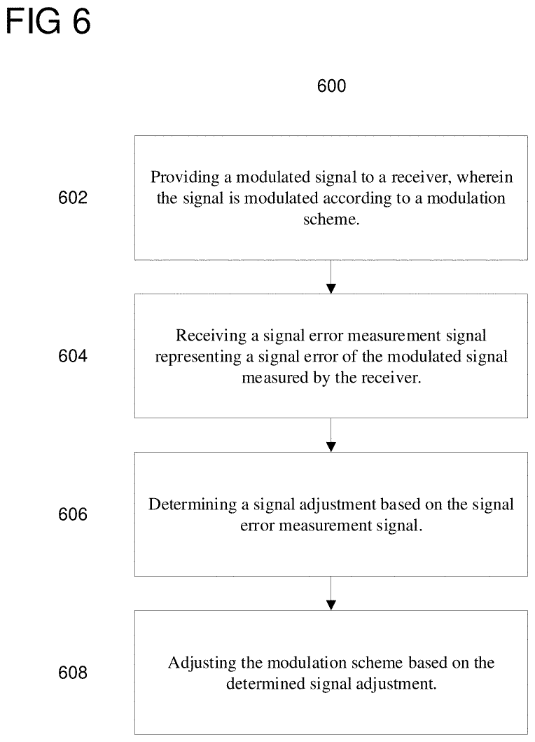

FIG. 6 shows exemplary method 600 of method of adjusting the constellation points of a constellation scheme. As shown in FIG. 6 method 600 includes providing a modulated signal to a receiver, wherein the signal is modulated according to a modulation scheme (stage 602). Method 600 may further include receiving a signal error measurement signal representing a signal error of the modulated signal measured by the receiver. (stage 604), determining a signal adjustment based on the signal error measurement signal. (stage 606), and determining a signal adjustment based on the signal error measurement signal (stage 608), and adjusting the modulation scheme based on the determined signal adjustment (stage 610).

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

The following examples disclose various aspects of this disclosure:

Example 1 is a communication device including one or more processors configured to generate a modulated signal, wherein the signal is modulated according to a modulation scheme; send the modulated signal; receive a signal error measurement signal representing a signal error of the modulated signal measured by a receiver of the modulated signal; determine a signal adjustment based on the signal error measurement signal; and adjust the modulation scheme based on the determined signal adjustment.

In Example 2, the subject matter of Example 1, may optionally further include wherein the modulations scheme defines a mapping of a plurality of constellation points to the modulated signal.

In Example 3, the subject matter of any one of Examples 1 or 2, may optionally further include wherein the plurality of constellation points are configured according to a quadrature amplitude modulation, wherein the quadrature amplitude modulation comprises four corner constellation points.

In Example 4, the subject matter of any one of Examples 1 to 3, may optionally further include, wherein the four constellation points are equally spaced with respect to adjacent constellation points.

In Example 5, the subject matter of any one of Examples 1 to 4, may optionally further include wherein the signal adjustment comprises an adjustment of the four corner constellation points.

In Example 6, the subject matter of any one of Examples 1 to 5, may optionally further include wherein the four corner constellation points are adjusted from a first position to a second position; and wherein the second position comprises a larger space between the four corner constellation and the adjacent constellation points than the first position.

In Example 7, the subject matter of any one of Examples 1 to 6, may optionally further include wherein the plurality of constellation points comprises 16 constellation points.

In Example 8, the subject matter of any one of Examples 1 to 6, may optionally further include wherein the plurality of constellation points comprises 64 constellation points.

In Example 9, the subject matter of any one of Examples 1 to 6, may optionally further include wherein the plurality of constellation points comprises 256 constellation points.

In Example 10, the subject matter of any one of Examples 1 to 9, may optionally further include wherein the signal error measurement signal comprises an error vector magnitude determined by the receiver of the modulated signal.

In Example 11, the subject matter of any one of Examples 1 to 10 may optionally further include wherein the signal error measurement signal comprises a bit error rate determined by the receiver of the modulated signal.

In Example 12, the subject matter of any one of Examples 1 to 11, may optionally further include wherein the signal error measurement signal comprises a modulation error ratio determined by the receiver of the modulated signal.

In Example 13, the subject matter of any one of Examples 1 to 12, may optionally further include a digital-to-analog converter; and wherein the digital-to-analog converter is configured to adjust the at least one of the plurality of constellation points.

In Example 14, the subject matter of any one of Examples 1 to 13, may optionally further include wherein the signal error measurement signal is received from a feedback loop of a phase locked loop.

In Example 15, the subject matter of any one of Examples 1 to 14, may optionally further include the receiver, wherein the receiver is connected to the communication device via a phase locked loop.

In Example 16, the subject matter of any one of Examples 1 to 15, may optionally further include wherein the receiver is configured to send the signal error measurement signal.

In Example 17, the subject matter of any one of Examples 1 to 16, may optionally further include wherein the one or more processors are further configured to determine an improvement measurement based on the signal adjustment, wherein the improvement measurement comprises a value representing a reduction in the signal error measurement after the modulation scheme adjustment based on the determined signal adjustment.

In Example 18, the subject matter of Example 17, may optionally further include wherein the one or more processors are further configured to compare the improvement measurement with an improvement threshold; and wherein the adjustment is based on the comparison.

Example 19 is a method including: generating a modulated signal, wherein the signal is modulated according to a modulation scheme; sending the modulated signal; receiving a signal error measurement signal representing a signal error of the modulated signal measured by a receiver of the modulated signal; determining a signal adjustment based on the signal error measurement signal; and adjusting the modulation scheme based on the determined signal adjustment.

In Example 20, the subject matter of Example 19, may optionally further include wherein the modulations scheme defines a mapping of a plurality of constellation points to the modulated signal.

In Example 21, the subject matter of any one of Examples 19 or 20, may optionally further include wherein the plurality of constellation points are configured according to a quadrature amplitude modulation, wherein the quadrature amplitude modulation comprises four corner constellation points.

In Example 22, the subject matter of any one of Examples 19 to 21, may optionally further include wherein the four constellation points are equally spaced with respect to adjacent constellation points.

In Example 23, the subject matter of any one of Examples 19 to 22, may optionally further include wherein the signal adjustment comprises an adjustment of the four corner constellation points.

In Example 24, the subject matter of any one of Examples 19 to 23, may optionally further include wherein the four corner constellation points are adjusted from a first position to a second position; and wherein the second position comprises a larger space between the four corner constellation and the adjacent constellation points than the first position.

In Example 25, the subject matter of any one of Examples 19 to 24, may optionally further include wherein the plurality of constellation points comprises 16 constellation points.

In Example 26, the subject matter of any one of Examples 19 to 25, may optionally further include wherein the plurality of constellation points comprises 64 constellation points.

In Example 27, the subject matter of any one of Examples 19 to 26, may optionally further include wherein the plurality of constellation points comprises 256 constellation points.

In Example 28, the subject matter of any one of Examples 19 to 27, may optionally further include wherein the signal error measurement signal comprises an error vector magnitude determined by the receiver of the modulated signal.

In Example 29, the subject matter of any one of Examples 19 to 28, may optionally further include wherein the signal error measurement signal comprises a bit error rate determined by the receiver of the modulated signal.

In Example 30, the subject matter of any one of Examples 19 to 29, may optionally further include wherein the signal error measurement signal comprises a modulation error ratio determined by the receiver of the modulated signal.

In Example 31, the subject matter of any one of Examples 19 to 30, may optionally further include determining an improvement measurement based on the signal adjustment, wherein the improvement measurement comprises a value representing a reduction in the signal error measurement after the modulation scheme adjustment based on the determined signal adjustment.

In Example 32, the subject matter of Example 31, may optionally further include comparing the improvement measurement an improvement threshold; and adjusting the at least one of the plurality of constellation points based on the comparison.

In Example 33, a communication device including one or more processors configured to provide a modulated signal to a receiver, wherein the signal is modulated according to a modulation scheme; receive a signal error measurement signal representing a signal error of the modulated signal measured by the receiver; determine a signal adjustment based on the signal error measurement signal; and adjust the modulation scheme based on the determined signal adjustment.

In Example 34, the subject matter of Example 33, may optionally further include one or more of the device according to Examples 2 to 18.

In Example 35, a method including providing a modulated signal to a receiver, wherein the signal is modulated according to a modulation scheme; receiving a signal error measurement signal representing a signal error of the modulated signal measured by the receiver; determining a signal adjustment based on the signal error measurement signal; and adjusting the modulation scheme based on the determined signal adjustment.

In Example 36, the subject matter of Example 35, may optionally further include one or more of the Examples device according to Examples 20 to 32.

Example 37 is a system including one or more devices according to Examples 1 to 18, 33, and 34 configured to implement a method according to Examples 19 to 32, 35, and 36.

Example 38 is one or more non-transitory computer readable media comprising programmable instructions thereon, that when executed by one or more processors of a device, cause the device to perform any one of the method of Examples 19 to 32, 35, and 36.

Example 39 is a means for implementing any of the Examples 1 to 18, 33, and 34.

While the disclosure has been particularly shown and described with reference to specific implementations, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A communication device comprising:
one or more processors configured to:
provide a modulated signal to a receiver, wherein the signal is modulated according to a modulation scheme;
receive a signal error measurement signal representing a signal error of the modulated signal measured by the receiver;
determine a signal adjustment based on the signal error measurement signal; and
adjust the modulation scheme based on the determined signal adjustment.

2. The communication device of claim 1, wherein the modulations scheme defines a mapping of a plurality of constellation points to the modulated signal.

3. The communication device of claim 2, wherein the plurality of constellation points are configured according to a quadrature amplitude modulation, wherein the quadrature amplitude modulation comprises four corner constellation points.

4. The communication device of claim 3, wherein the four constellation points are equally spaced with respect to adjacent constellation points.

5. The communication device of claim 4, wherein the signal adjustment comprises an adjustment of the four corner constellation points.

6. The communication device of claim 5, wherein the four corner constellation points are adjusted from a first position to a second position; and
wherein the second position comprises a larger space between the four corner constellation and the adjacent constellation points than the first position.

7. The communication device of claim 6, wherein the plurality of constellation points comprises 16 constellation points.

8. The communication device of claim 2, wherein the signal error measurement signal comprises an error vector magnitude determined by the receiver of the modulated signal.

9. The communication device of claim 2, wherein the signal error measurement signal comprises a bit error rate determined by the receiver of the modulated signal.

10. The communication device of claim 2, further comprising a digital-to-analog converter; and
wherein the digital-to-analog converter is configured to adjust the at least one of the plurality of constellation points.

11. The communication device of claim 1, wherein the signal error measurement signal is received from a feedback loop of a phase locked loop.

12. The communication device of claim 11, further comprising the receiver, wherein the receiver is connected to the communication device via a phase locked loop.

13. The communication device of claim 1, wherein the receiver is configured to send the signal error measurement signal.

14. A method comprising:
providing a modulated signal to a receiver, wherein the signal is modulated according to a modulation scheme;
receiving a signal error measurement signal representing a signal error of the modulated signal measured by the receiver;
determining a signal adjustment based on the signal error measurement signal; and
adjusting the modulation scheme based on the determined signal adjustment.

15. The method of claim 14, wherein the modulations scheme defines a mapping of a plurality of constellation points to the modulated signal.

16. The method of claim 15, wherein the plurality of constellation points are configured according to a quadrature amplitude modulation, wherein the quadrature amplitude modulation comprises four corner constellation points.

17. The method of claim 15, wherein the plurality of constellation points comprises 16 constellation points.

18. The method of claim 15, wherein the signal error measurement signal comprises an error vector magnitude determined by the receiver of the modulated signal.

19. The method of claim 14, further comprising determining an improvement measurement based on the signal adjustment, wherein the improvement measurement comprises a value representing a reduction in the signal error measurement after the modulation scheme adjustment based on the determined signal adjustment.

20. The method of claim 19, further comprising comparing the improvement measurement to an improvement threshold; and
adjusting the at least one of the plurality of constellation points based on the comparison.
